(19) United States
(12) Patent Application Publication
(10) Pub. No.: US 2015/0257344 A1
(43) Pub. Date: Sep. 17, 2015

(54) Cultivation Crop Separator

(71) Applicant: Duane Earl Rolfson, Austin, MN (US)

(72) Inventor: Duane Earl Rolfson, Austin, MN (US)

(21) Appl. No.: 14/208,038

(22) Filed: Mar. 13, 2014

(51) Int. Cl. A01G 25/09

(52) U.S. Cl. CPC A01G 25/09

(57) ABSTRACT

The invention is a crop separator comprising a main platform and two angled arms and at least one attaching member with bolt holes to attach the crop separator to irrigation machinery. The angled arms, together with the outer edge of the main platform, form a smooth outer crop abutting surface such that when the crops first touch one of the angled arms, the crops are allowed to slide along the outer crop abutting surface without catching on any rough surface, ripping out the crop or otherwise damaging the crop.

### BACKGROUND OF THE INVENTION

### Field of the Invention

The present invention is related to an apparatus for separating crops as machinery or equipment is moved through a crop field, thereby reducing or eliminating damage to the crop. More particularly, the present invention is directed to an apparatus that attaches to an irrigation system such that as the irrigation machinery moves through the crop, the crop is gently moved aside so the irrigation machinery does not damage or destroy the crop or break corn stalks.

### SUMMARY OF INVENTION

Accordingly, it is a primary object of the present invention to provide for a reduction or elimination of crop damage by the irrigation machinery as that irrigation machinery moves through the crop field.

The invention is a crop separator comprising a main platform and two angled arms, one angled arm being a forward angled arm and the other angled arm being a rearward angled arm, the main platform further comprising a generally rectangular shape, an outer edge, an inner edge, a leading edge and a trailing edge and at least one attaching member. The at least one attaching member is fixedly attached to the inner edge of the main platform. Fixedly attaching the attaching member can be accomplished by welding the attaching member to the main platform, by using bolts or the like, or by manufacturing the main platform as a one piece unit with the attaching member being formed by bending the main platform about one-third its length from the inner edge at a ninety degree angle, the attaching member being formed by the bend and comprising the one-third length of the main platform, so that the main platform has an L-shape, the attaching member being the shorter of the “L” that is vertical when attached to the irrigation machinery, and the remainder of the main platform forming a horizontal step surface, thereby allowing the farmer to step up onto the main platform to climb the irrigation machinery for repair and maintenance.

The attaching member comprises a plurality of bolt holes for mounting the crop separator onto the reverse side of the gear box of the irrigation machinery. The bolt holes would be located on the attaching member to align with existing gear box bolts in the reverse side of the gear box. The crop separator attaches to the irrigation machinery by removing a plurality of gear box bolts from the reverse side of the gear box on a wheel of the irrigation machinery, aligning the bolt holes in the attaching member to the reverse side of the gear box bolt holes and removably affixing the attaching member to the reverse side of the gear box with bolts, inserted through the bolt holes and screwed into the gear box bolt holes. Bolts used to attach the attaching member must be sufficiently longer than the gear box bolts to allow for the width of the attaching member and still be able to screw into the gear box bolt holes the same or similar depth as the original gear box bolts.

The two angled arms, each comprising two ends, are fixedly attached to the outer edge of the main platform at one end such that they angle inward towards the irrigation machinery from the outer edge of the main platform, one angled arm projecting forward in relation to the movement of the irrigation machinery and the other angled arm projecting rearward in relation to the movement of the irrigation machinery. The angled arms, together with the outer edge of the main platform, form a smooth outer crop abutting surface such that when the crops first touch the angled arms, the crops are allowed to slide along the outer crop abutting surface without catching on any rough surface and ripping out the crop or otherwise damaging the crop.

A further embodiment would have one angled arm, attached to the main platform and projecting forward in relation to the movement of the irrigation machinery.

Another embodiment of the crop separator has two attaching members, one fixedly attached to the leading edge of the main platform and the other fixedly attached to the trailing edge of the main platform. The attaching members would each be attached to the main platform at a ninety degree angle to the main platform. In this embodiment, each attaching member would comprise a plurality of bolt holes for removably attaching the crop separator to the irrigation machinery where the irrigation machinery has horizontally placed bolt holes in vertical flanges on its irrigation machinery frame near the gear box. The crop separator would be attached to the irrigation machinery by placing bolts through the attaching members' bolt holes and screwing them into the bolt holes in the vertical flanges of the irrigation machinery frame near the gear box. In irrigation machinery where the bolt holes in the vertical flanges of the irrigation machinery frame are not threaded, then nuts would be screwed and tightened onto the bolts after the bolts have been placed through the attaching member bolt holes and the bolt holes in the vertical flanges of the irrigation machinery frame near the gear box to secure the attaching members to the irrigation machinery frame.

As with the previous embodiment, fixedly attaching the attaching members can be accomplished by welding each attaching member to the main platform, or by using bolts or the like, or by manufacturing the main platform as a one piece unit with the attaching members being formed by bending the main platform about one-quarter its length from the leading edge and one-quarter its length from the trailing edge, each at a ninety degree angle, the attaching members being formed by the respective bends and comprising the one-quarter length of the main platform, so that the main platform has a shallow U-shape, the attaching members being the shorter sides of the “U” that are vertical when attached to the irrigation machinery, and the remainder of the main platform forming a horizontal step surface, thereby allowing the farmer to step up onto the main platform to climb the irrigation machinery for repair and maintenance.

Each attaching member comprises bolt holes to allow the attaching members to be removably attached to the flanges of the irrigation machinery frame near the gear box area of an irrigation machinery such that the crop separator main platform outer edge is facing away from the irrigation machinery. Removable attachment means can be bolts, screws or the like. The two angled arms are fixedly attached to the outer edge of the main platform such that they angle towards the irrigation machinery from the outer edge of the main platform, one angled arm projecting forward in relation to the movement of the irrigation machinery and the other angled arm projecting rearward in relation to the movement of the irrigation machinery. The angled arms, together with the outer edge of the main platform, form a smooth outer crop abutting surface such that when the crops first touch the angled arms, the crops are allowed to slide along the outer crop abutting surface without catching on any rough surface and ripping out the crop or otherwise damaging the crop.

The crop separator is preferably made of hardened steel, iron or another like hard metal. The various elements of the crop separator can be manufactured separately and welded or otherwise fixedly attached to each other, or the main platform and attaching member or members can be made out of one piece of rectangular shaped metal and bent to form the L-shape or the U-shape, with the attaching member or members projecting perpendicular from the main platform leading and trailing edges, respectively. The angled arms could also be manufactured from a single bar of metal, such as steel, and bent such that the bar of steel comprises a straight middle portion which is fixedly attached to the outer edge of the main platform, and two angled end portions, each angled inward in relation to the outer edge of the main portion such that each is angled inward toward the irrigation machinery.

The preferred embodiment of the crop separator has dimensions as follows: each angled arm would be 12 to 17 inches long and be made of a ¾ inch steel bar, the main platform would be generally rectangular with dimensions of 7 to 9½ inches by 7 to 8 inches, and would be made of ¼ to ½ inch steel plate. The attaching member of the main platform would have dimensions of 2 to 3½ inches by 7 to 8 inches. The bolt holes would be ½ to ¾ inches in diameter. Alternatively, if the angled arms are made out of a single steel bar, the length of that bar would be between 36 and 40 inches, with each bend to form an angle of 45 to 55 degrees with the leading and trailing edge of the main platform, respectively.

### SUMMARY DESCRIPTION OF DRAWINGS

FIG. 1 is a perspective view from the top of the preferred embodiment of the crop separator.

FIG. 2 is a front view of the crop separator.

FIG. 3 is a top view of the crop separator.

FIG. 4 is a perspective view of another embodiment of the crop separator.

FIG. 5 is a perspective view of another embodiment of the crop separator shown in FIG. 4.

### DETAILED DESCRIPTION OF DRAWINGS

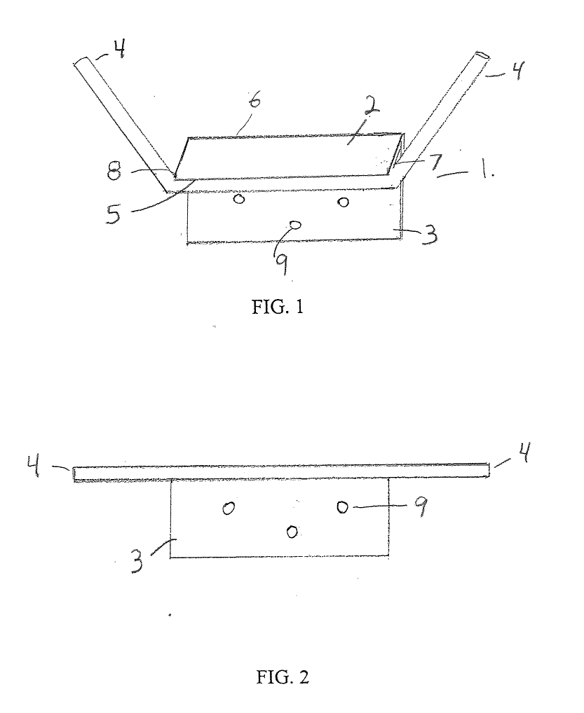

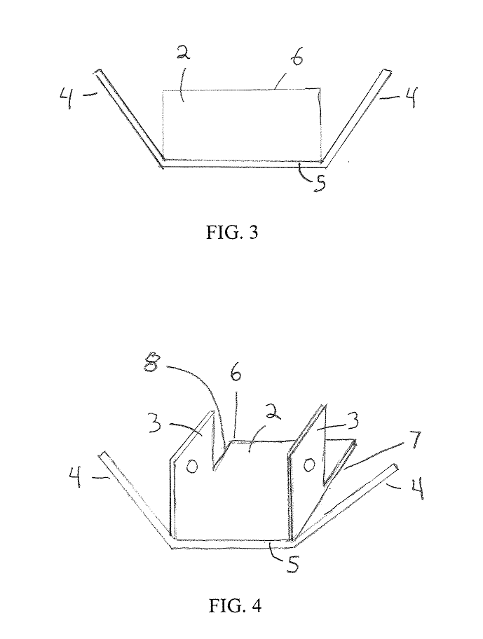

Referring to FIGS. 1, 2 and 3, the preferred embodiment of the crop separator 1 is shown with a main platform 2, an attaching member 3, and two angled arms 4, the main platform 1 further comprising a generally rectangular shape, an outer edge 5, an inner edge 6, a leading edge 7 and a trailing edge 8. The attaching member 3 is fixedly attached to inner edge 6 of the main platform 2. The attaching member comprising a plurality of bolt holes 9 to allow the attaching member to be removably attached to the reverse side of gear box area of the irrigation machinery such that the crop separator main platform outer edge is facing away from the irrigation machinery. The two angled arms are fixedly attached to the outer edge of the main platform such that they angle towards the irrigation machinery, one angled arm projecting forward in relation to the movement of the irrigation machinery and the other angled arm projecting rearward in relation to the movement of the irrigation machinery.

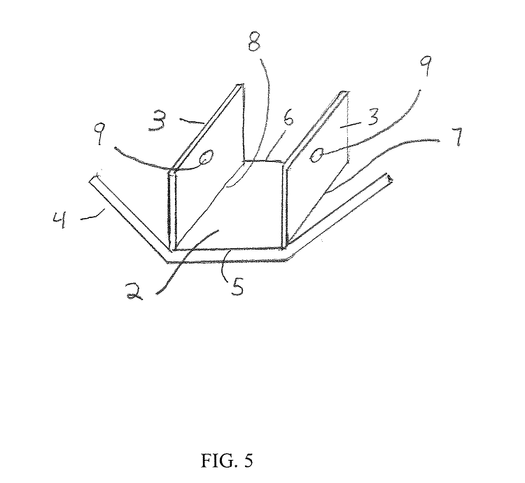

Referring to FIGS. 4 and 5, another embodiment of the crop separator is shown with a main platform 2, two side attaching members 3, and two angled arms 4, the main platform further comprising a generally rectangular shape, an outer edge 5, an inner edge 6, a leading edge 7 and a trailing edge 8. The two side attaching members are fixedly attached to the main platform, one to the leading edge and the other to the trailing edge. The side attaching members are of sufficient length and width to fit the irrigation machinery while allowing a user to step up onto the main platform 2. Each attaching member comprising at least one bolt hole to allow the attaching members to be removably attached to the irrigation machinery frame near the gear box area of an irrigation machinery such that the crop separator main platform outer edge is facing away from the irrigation machinery. The two angled arms are fixedly attached to the outer edge of the main platform such that they angle towards the irrigation machinery, one angled arm projecting forward in relation to the movement of the irrigation machinery and the other angled arm projecting rearward in relation to the movement of the irrigation machinery.

In use, the crop separator would be attached to the reverse side of gear box area of an irrigation machinery, and as that irrigation machinery moved through the crop field, the forward facing angled arm would apply pressure to the corn stalk, gently bending or moving the stalk of corn away from the irrigation machinery reverse side of gear box area and, as the irrigation machinery moved past the corn stalk, the stalk would slide along a bottom support frame of the irrigation machinery frame and gently be allowed to bend or move back to its original state as the angled arm on a trailing crop separator that is attached to a trailing wheel gear box reduces the pressure against the corn stalk, thus reducing or eliminating damage to the corn stalk as the irrigation machinery moved through the corn field.

I claim:

1. A cultivation crop separator comprising
a main platform,
the main platform comprising a rectangular shape having an outer edge, an inner edge, a leading edge, a trailing edge, and at least one attaching member,
the at least one attaching member comprising at least one bolt hole for attachment to a piece of farm machinery,
a forward angled arm and a rearward angled arm, each angled arm having two ends,
one end of the forward angled arm being fixedly attached to the outer edge of the main platform near the leading edge of the main platform and one end of the rearward angled arm being fixedly attached to the outer edge of the main platform near the trailing edge of the main platform, such that each angled arm projects from the outer edge of the main platform towards the irrigation machinery.

2. The crop separator of claim 1 wherein the main platform, the forward angled arm and the rearward angled arm are made of steel.

3. The crop separator of claim 1 wherein the main platform further comprises an L-shaped bend of sufficient length to accommodate the at least one bolt hole such that the at least one bolt hole aligns with one or more bolt holes on a gear box of the farm machinery for attaching the crop separator to the farm machinery.

4. The crop separator of claim 1 wherein the forward angled arm and the rearward angled arm are made of a one-piece metal rod, the metal rod comprising a straight middle portion which is fixedly attached to the outer edge of the main platform, and two angled end portions, each angled inward in relation to the outer edge of the main portion such that each is angled inward toward the irrigation machinery.

5. The crop separator of claim 1 wherein the angled arms together with the outer edge of the main platform, form a smooth outer crop abutting surface.

6. The crop separator of claim 1 wherein the at least one attaching member comprises two attaching members, one attaching member fixedly attached to the leading edge of the main platform and the other attaching member fixedly attached to the trailing edge of the main platform.

7. The crop separator of claim 6 wherein the main platform further comprises a U-shaped bend, each side of the U-shape of sufficient length to accommodate at least one bolt hole, each U-shape side bolt hole situated to align with a bolt hole on a vertical flange of an irrigation machinery frame near the gear box of the farm machinery for removably attaching the crop separator to the farm machinery.
